(19) United States
(12) Patent Application Publication
(10) Pub. No.: US 2015/0256087 A1
(43) Pub. Date: Sep. 10, 2015

(54) Soft Switching Converter with Dual Transformer by Steering the Magnetizing Current

(71) Applicant: Ionel Jitaru, Tucson, AZ (US)

(72) Inventor: Ionel Jitaru, Tucson, AZ (US)

(21) Appl. No.: 14/535,993

(22) Filed: Nov. 7, 2014

Related U.S. Application Data
(60) Provisional application No. 61/901,313, filed on Nov. 7, 2013.

(51) Int. Cl. H02M 3/335

(52) U.S. Cl. CPC H02M 3/33546

(57) ABSTRACT

A design and control method is shown to create soft transition in dual transformer half bridge or full bridge topology by controlling the magnetizing current in both transformers to cross zero level and allows soft switching on all the switching elements.

### RELATED APPLICATION/CLAIM OF PRIORITY

This application is related to and claims priority from U.S. provisional application Ser. No. 61/901,313, filed Nov. 7, 2013, and which is incorporated by reference herein.

### 1. INTRODUCTION

Traditional pulse width modulation (PWM) controlled converters have been around for a long time. They have some characteristics which are useful. The current waveforms in continuous mode versions are square and have low RMS content compared to resonant converters. But they have hard switching in the primary and reverse recovery problems in the secondary. Because of this there have been some modifications to them to reduce some these draw backs. Almost all of the modifications have address soft switching in the primary. Traditionally the zero voltage switching topologies have focused in obtaining zero voltage switching on the primary switchers.

U.S. provisional application Ser. No. 61/821,896, filed May 10, 2013, and U.S. non provisional application Ser. No. 14/274,701 each addresses this issue, and this application builds on and further develops the concepts of U.S. provisional application Ser. No. 61/821,896 and U.S. non provisional application Ser. No. 14/274,701, each of which is incorporated by reference herein. A copy of U.S. non provisional application Ser. No. 14/274,701 is attached as exhibit A, and is incorporated by reference herein. The goal has been to eliminate switching losses in the primary especially in application wherein the input voltage is larger, such as 200V to 400V. An additional inductive element or a larger leakage inductance is necessary in zero voltage switching prior art topologies to delay the flow into the secondary and allow a zero voltage switching across the primary switchers as depicted in U.S. Pat. No. 5,231,563.

### SUMMARY OF THE PRESENT INVENTION

The goal of the present application is to have soft switching in primary and secondary as well which will turn off the rectifier means at zero current and to turn on primary switchers at zero voltage. This shall be done without any additional magnetic elements.

The present invention accomplishes this goal by providing a design and control method for a converter with dual transformers and synchronous rectifiers, which uses the magnetizing current in both transformers to shape the current through the synchronous rectifiers to become negative so that soft transitions are obtained in all switching devices in the converter.

In a more specific aspect of the design and control method of the invention, the amount of negative current through the synchronous rectifier and the time between turn off of the synchronous rectifier and turn on of the correspondent primary switching device is tailored that the correspondent primary switching device turns on at zero voltage switching conditions. Moreover, the dual transformers of the converter are integrated on the same magnetic core. In addition, regulation of the output current and output voltage of the power converter is can be also done through train of pulses, especially at light loading conditions or very high frequency of operation. This is done by turning off periodically some or all the switching elements for a determined period of time. Also, the magnetizing current in each set of dual transformers is tailored through modulation in frequency in such a way that the claimed conditions do occur over a predetermined range of input and output loading conditions. Additionally, a controller can be provided that controls all switching devices of the converter to produce optimum frequency for a predetermined power parameter of the converter. For example if the parameter of interest is the efficiency, then the frequency of operation is tailored in a way wherein the efficiency is optimized. That may mean that the primary switching devices will turn on at lower voltage than the hard switching mode but not necessarily at zero voltage.

Further aspects of the present invention are described below, in conjunction with the accompanying figures.

### BRIEF DESCRIPTION OF THE FIGURES

FIG. 1 shows a half bridge topology according to the present invention, which uses two transformer structures instead of a conventional arrangement employing a transformer and an inductor;

FIG. 2 shows key waveforms of the topology of FIG. 1;

FIGS. 3A-3D show a methodology of integrating both transformers into a single core and the preferred location of the synchronous rectifiers and the output capacitor;

FIG. 4A shows a gapping methodology in the prior art and FIG. 4B show the preferred gapping in the present invention wherein both transformers are integrated in the same ferrite core. FIGS. 4C and 4D show additional gapping methodology to further optimize the converter operation.

FIGS. 5A and 5B show a method of interconnecting the primary winding from a transformer to another transformer in the case when both transformers are integrated in the same ferrite core.

FIGS. 6A and 6B show waveform and pulse diagrams, for a converter with topology according to the present invention wherein the modulation is done through train of pulses.

FIGS. 7A and 7B shows a method of coupling the two transformers in the ferrite core which shapes the magnetizing current with higher slope during the dead time period as depicted in FIG. 7B.

### DETAILED DESCRIPTION

As described above, the present invention provides a design and control method for a converter with dual transformers and synchronous rectifiers, which uses the magnetizing current in both transformers to shape the current through the synchronous rectifiers to become negative so that soft transitions are obtained in all switching devices in the converter. The invention is described herein in connection with a half bridge converter topology, and with this description in mind, the manner in which the present invention can be implemented in various converter topologies will be apparent to those in the art.

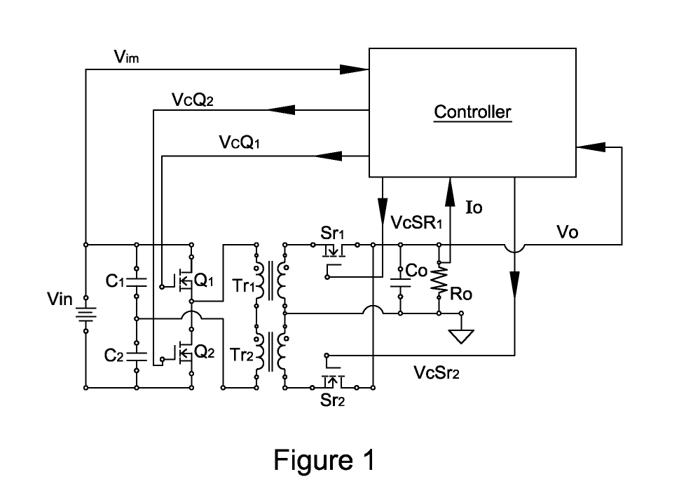

In FIG. 1 is presented a half bridge topology which is using two transformers structures instead of a conventional arrangement employing a transformer and an inductor. This topology is known in our field and it is described in some publication such as the APEC 2009, Feb. 15, Washington D.C., and Professional Education Seminar Workbook, seminar 16, and pages 37, 38 and 39. Each transformer has two functions one as a transformer and another one as an inductor. When one of the transformers acts in a forward mode transferring the energy from the primary to secondary the second one acts as an inductor and vice versa.

The novelty of this invention is the mode of operation through the sizing of the magnetic elements, the timing and the control mechanism which totally change the mode of operation and accomplishes several goals such as zero voltage switching on the primary Mosfets Q1 and Q2 and slight negative or zero current at turn off through SR1 and Sr2. Soft switching in primary and secondary allows us to operate at much higher frequency with very good efficiency.

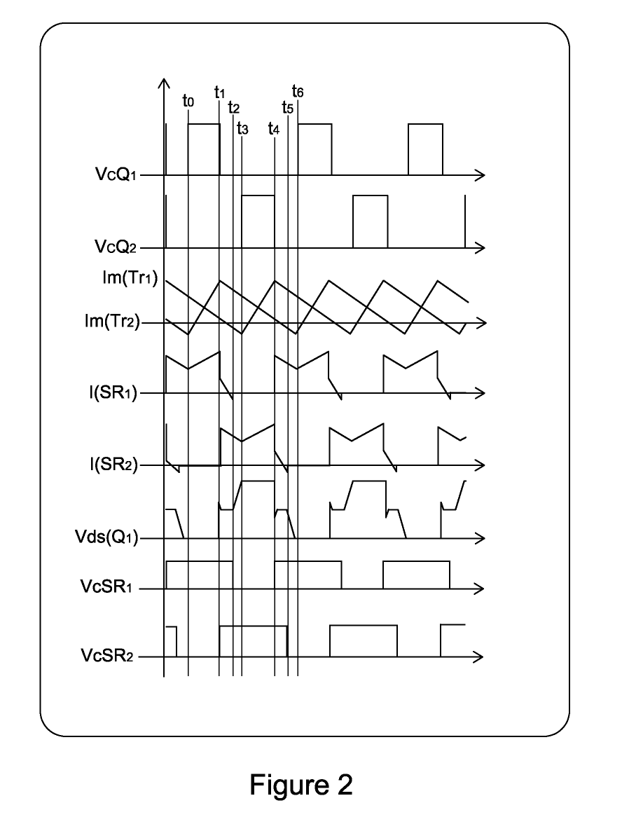

The key waveforms in this topology are presented in FIG. 2.

At time t0 Q1 is turned on at zero voltage switching conditions as depicted by the Vds(Q1). SR1 was already in conduction at that time as depicted by I (SR1). During the conduction time of Q1 the energy is transferred from primary to secondary in a forward mode via TR1. During Q1 conduction the magnetizing current through TR2 is increasing as depicted by Im (Tr2). In conclusion during the conduction time of Q1, energy is delivered to the load in a forward mode through Tr1 and energy is stored in the magnetic field of Tr2.

At the moment t1, Q1 is turned off and the voltage across Q1 builds up to Vin/2. Some additional ringing may be added to that level function of the leakage inductance between primary and secondary in Tr1 and Tr2. After Q1 is turned off the SR2 is turned on and the magnetizing current through TR2 starts flowing through SR2 as depicted by I(SR2). When Q1 turns off the magnetizing current through Tr2 and Tr1 and the current through SR1 and SR2 stars decaying. By design the current through SR1 is reaching zero before the time t2. The SR1 is still kept on after the current reaches zero for a small period of time in order to reach predetermined negative value. To ensure that the current through SR1 reaches zero somewhere between t1 and t2 under different line and loading conditions the frequency of operation will vary accordingly. At heavy loads the frequency will be lower and at the lighter loads the frequency will be higher until reaches a certain upper level. Above that frequency the operation will go into a train of pulses mode as will be further described in this invention.

At t2 the SR1 is turned off at slight negative current through it. The negative current through SR1 at turn off is named “push back current”. The “push back current” will reflect in the primary and will continue to flow through the parasitic capacitance of Q2 discharging it and creating zero voltage turn on conditions for the Q2. The time interval between t2 and t3 is the soft transition period when the voltage across Q2 decays towards zero. This transition time is function of “push back current” and the parasitic capacitance across the primary switching devices.

At t3 Q2 is turned on under zero voltage conditions. SR2 was already in conduction at that time as depicted by I (SR2). During the conduction time of Q2 the energy is transferred from primary to secondary in a forward mode via TR2. During Q2 conduction the magnetizing current through TR1 is increasing as depicted by Im (Tr1). In conclusion during the conduction time of Q2, energy is delivered to the load in a forward mode through Tr2 and energy is stored in the magnetic field of Tr1.

At the moment t4, Q2 is turned off and the voltage across Q2 builds up to Vin/2. Some additional ringing may be added to that level function of the leakage inductance between primary and secondary in Tr1 and Tr2. After Q2 is turned off the SR1 is turned on and the magnetizing current through TR1 starts flowing through SR1 as depicted by I (SR1). When Q2 turns off the magnetizing current through Tr1, Tr2 stars decaying. By design the current through SR2 is reaching zero before the time t5. The SR2 is still kept on after the current reaches zero for a small period of time in order to reach predetermined negative value. To ensure that the current through SR2 reaches zero sometimes between t4 and t5 under different line and loading conditions the frequency of operation will vary accordingly. At heavy load the frequency will be lower and at the lighter load the frequency will be higher until reaches a certain upper level. Above that the operation will go into a train of pulses mode as will be further described in this invention.

At t5 the SR2 is turned off at slight negative current through it. The negative current through SR2 at turn off is the “push back current”. The “push back current” will reflect in the primary and will continue to flow through the parasitic capacitance of Q1 discharging it and creating zero voltage turn on conditions for the Q1. The time interval between t5 and t6 is the soft transition period when the voltage across Q1 decays towards zero.

At the moment t6, Q1 is turned on under zero voltage switching conditions and the behavior of the circuit repeats as it was at t0.

In conclusion in this topology we accomplish zero voltage switching conditions for the primary switchers and zero or slight negative current at turn off for the secondary synchronous rectifiers. The slight negative current at turn off through the secondary synchronous rectifiers named also “push back current” reflects in the primary and discharges the parasitic capacitance of the primary switchers to zero before the primary switchers turn on. In order to ensure that the current through the synchronous rectifiers reaches zero after the conduction of one of the primary switchers and before the other primary switch turns on, the frequency of operation will change versus output current level. At higher output current the frequency will decrease and at lighter current the frequency will increase. A controller as described in FIG. 1 monitors the output voltage, output current and input voltage and adjusts the frequency of operation and the time interval between t3 and t2 and the time interval between t6 and t5 in order to ensure best switching conditions for all switching devices. This control can be done through a look up table method, real time computing or algorithmic machines.

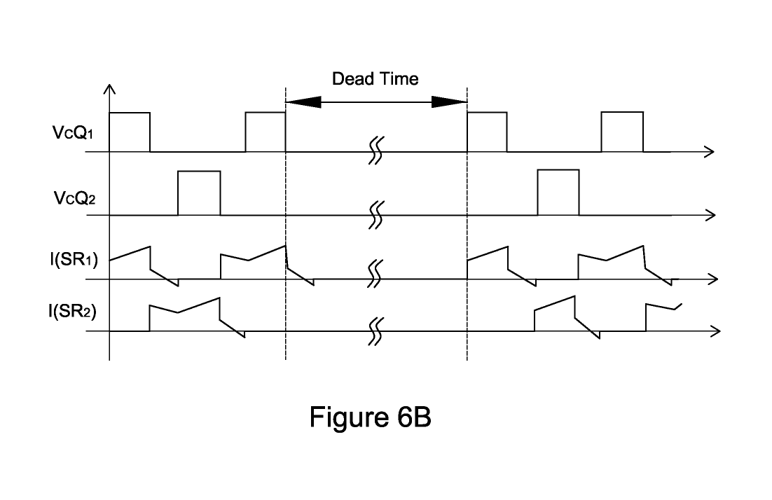

The frequency will increase at lighter load but there is an upper limit to it. For light load the operation can change to regulation through train of pulses in some applications wherein the efficiency at very light load is an important parameter. This type of operation it is very suitable with the topology because the magnetizing current reaches zero or near zero at each cycle. The pulses can be interrupted for an extended period of time as presented in FIG. 6A. In the case the efficiency during the operation is high the overall efficiency during the entire cycle including the dead time is high as well. The power processing of the converter during the operation time is tailored to be very efficient. The power consumption of the power train and control during the dead time is designed to be very low and as a result the overall efficiency of the converter will be very close to the efficiency during the operation time.

In FIG. 6B is presented in detail the key waveforms such as the drive signals for the primary Mosfets and the current through the synchronized rectifiers before and after the dead time. The current through the synchronous rectifiers reaches zero or slight below zero at the end of each cycle. SR1 is turned off after the last turn on signal on Q1 and the SR2 turns off after the last turn on signal on Q2. All the switchers, Q1, Q2, SR1 and SR2 are kept off during the dead time. The fact that the magnetizing current was zero through each transformer when the synchronized rectifiers turn off allows the circuit to preserve the final conditions which will be equal with the initial conditions of the power train after the dead time. This makes this topology suitable with the train of pulses modulation technique. After the dead time period the Q1 and Q2 switchers are activated and also the SR1 and SR2 as presented in FIG. 6B.

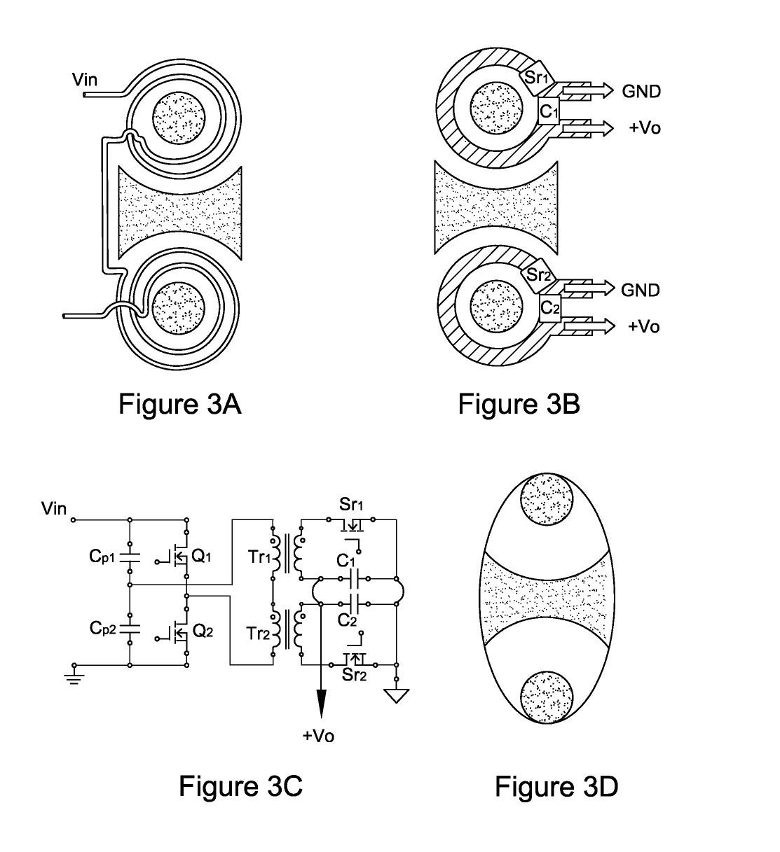

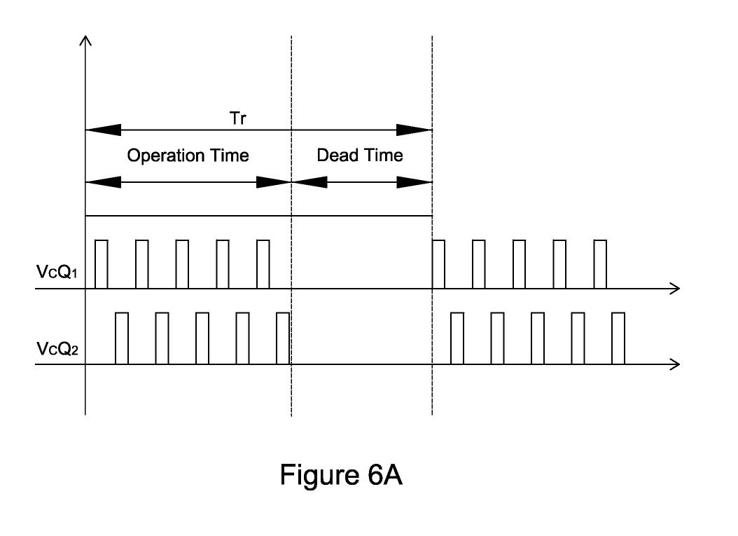

The schematic presented in FIG. 1 is also depicted in FIG. 3C with some slight changes which do not change the mode of operation of the topology. The synchronous rectifiers SR1 and SR2 a placed with the source to the ground, as it will be implemented for practical purposes. The output capacitor Co is split into two capacitors each one placed very close to the each transformer. In one of the embodiment this topology can be implemented by placing both transformers on the same magnetic core. In FIG. 3A is presented the primary winding methodology. In FIG. 3B is presented the secondary winding, in this case only one turn and the placement of the synchronous rectifiers and the output capacitors. Each synchronous rectifier and its capacitor are in series and are part of the one turn structure. The ground connection and the Vo+ connection will carry just dc current. In such implementation we eliminate the termination effect and reduce the copper losses and increase the efficiency. In the same time in this implementation we reduce the stray inductance. The top view of such a magnetic structure with the I section removed is presented in FIG. 3D. In another embodiment of this invention the center leg has a cut out to allow the primary winding to connect from one transformer to another as depicted in FIG. 5A and FIG. 5B. This implementation will add an additional inductor created by the small section of the primary winding going through the center post and the magnetic core of the center post. This additional inductance will allow us in some application to facilitate zero voltage switching in the primary side.

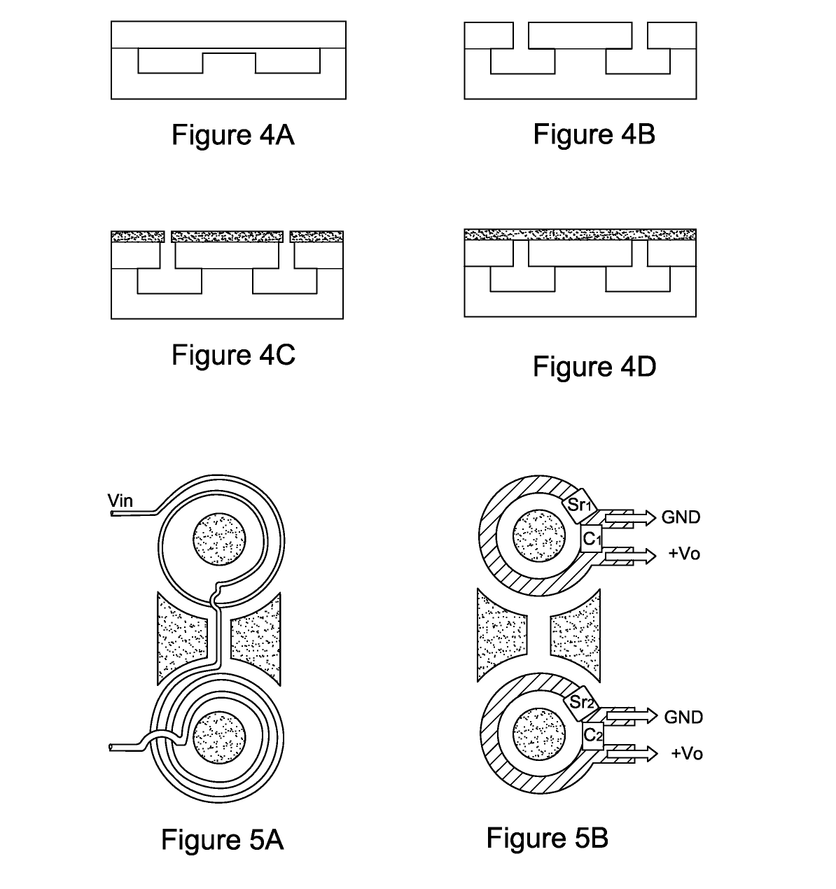

This form of integrated magnetic is presented in some publication such as seminar notes APEC 2009, Feb. 15, Washington D.C., Professional Education Seminar Workbook, seminar 16, and pages 43 and 44. In the prior art implementations the center leg is gapped for energy storage as depicted in FIG. 4A. One of the embodiments of this invention is the placement of the gap on the oval I section as depicted in FIG. 4B. In such an implementation we reduce the copper losses associated to the gap effect and also allow us to better control the coupling in between the two transformers. Another gap can be also placed on the bottom side of the core symmetrically under the top gap. This will further reduce the copper loss associated with the gap effect. In some cases we may have to use swing transformers wherein the magnetizing inductance will change versus the load as depicted in FIG. 4C. At lighter loads the magnetizing inductance is higher and we do not have to increase the frequency of operation too much. At higher loads the magnetizing inductance is lower and in this case the frequency shift between the operation at light load and high load will not be very large.. In some cases the gap is practically eliminated for a portion of the top I section core, as depicted in FIG. 4D, and this will lower the level of the current at which the swing inductor will be activated.

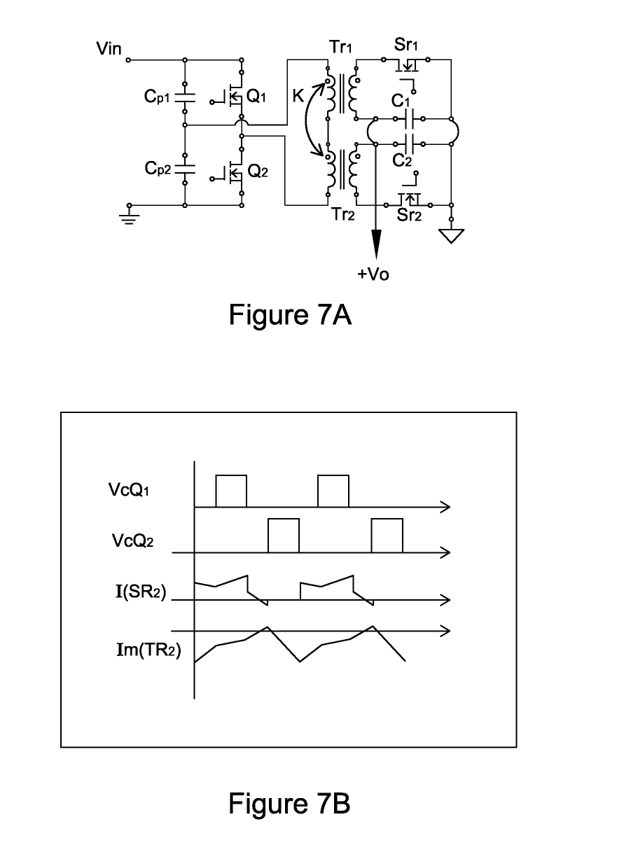

In FIG. 7A is presented another embodiment of the invention wherein there is a coupling between Tr1 and Tr2 as presented in the picture. This coupling in between the transformers is function of the geometry of the core and the size of the gaps placed on the I section of the magnetic core. The coupling between the transformers does impact the shape of the magnetizing current through each transformer. During the conduction of Q1 and Q2 when the input voltage is placed across both primaries of the transformers the equivalent magnetizing inductance of the transformers is larger given by the following formula L(m)_equivalent=Lm1+Lm2+2kLm1Lm2. As a result the slope of the magnetizing current during Q1 and Q2 conduction is smaller as depicted in FIG. 7B. During the off time of Q1 and Q2 the magnetizing inductance through each transformer will shape the magnetizing current with much larger slope. This has the advantage that it increases the down slope of the current through SR1 and SR2 when crossing the zero level. In this way we have a better control on the push back current.

Though all of the drawings presented are focused on the half bridge topology the same concept can be applied to the full bridge topologies or asymmetrical half bridge and full bridge topology, push pull or two transistor forward.

Thus, as seen from the foregoing description, the present invention provides a design and control method for a converter with dual transformers and synchronous rectifiers, which uses the magnetizing current in both transformers to shape the current through the synchronous rectifiers to become negative so that soft transitions are obtained in all switching devices in the converter. With this description in mind, the manner in which the present invention can be implemented in various converter topologies will be apparent to those in the art.

1. A design and control method for a converter with dual transformers and synchronous rectifiers, comprising using the magnetizing current in both transformers to shape the current through the synchronous rectifiers to become negative so that soft transitions are obtained in all switching devices in the converter.

2. A design and control method for a converter with dual transformers and at least two primary switching devices and at least two synchronous rectifiers in the secondary wherein each of the primary switching device is off when a correspondent synchronous rectifier is on, wherein the amount of negative current through the synchronous rectifier and the time between turn off of the synchronous rectifier and turn on of the correspondent primary switching device is tailored that the correspondent primary switching device turns on at zero voltage switching conditions.

3. The design and control method of any of claims 1 or 2 wherein the dual transformers of the converter are integrated on the same magnetic core.

4. The design and control method of claim 3 wherein the magnetizing current in each set of dual transformers is tailored through modulation in frequency in such way that the claimed conditions of claims 1 or 2, respectively, do occur over a predetermined range of input and output loading conditions.

5. The design and control method of claim 3 wherein the power transfer from primary to the secondary is controlled by turning off periodically some or all the switching elements for a determined period of time.

6. The design and control method of claim 3 using a controller that controls all switching devices of the converter to produce optimum frequency for controlling a predetermined power parameter of the converter.

7. The design and control method of any of claims 1 or 2 using a controller that controls all switching devices of the converter to produce optimum frequency for controlling a predetermined power parameter of the converter.

8. The design and control method of any of claims 1 or 2 wherein the magnetizing current in each set of dual transformers is tailored through modulation in frequency in such way that the claimed conditions of claims 1 or 2, respectively do occur over a predetermined range of input and output loading conditions.

9. The design and control method of any of claims 1 or 2 wherein the power transfer from primary to the secondary is controlled by turning off periodically some or all the switching elements for a determined period of time.
